(19) United States
(12) Patent Application Publication
(10) Pub. No.: US 2005/0107282 A1
(43) Pub. Date: May 19, 2005

(54) Wipes and their use

(75) Inventors: Francis Cornelio Ford, Cincinnati, OH (US); Peter Robert Foley, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/704,883

(22) Filed: Nov. 10, 2003

Related U.S. Application Data
(60) Provisional application No. 60/426,185, filed on Nov. 14, 2002.
(60) Provisional application No. 60/491,719, filed on Aug. 1, 2003.

(51) Int. Cl. C11D 17/00

(52) U.S. Cl. 510/438

(57) ABSTRACT

A wipe that includes a water-insoluble substrate having a cleaning composition applied thereto is disclosed. The cleaning composition includes a surfactant and a bleach. In certain embodiments, the bleach can be a peroxy carboxylic acid or a hydrophilic precursor thereof.

### CROSS REFERENCE TO RELATED APPLICATIONS

This application claims the benefit of U.S. Provisional Application No. 60/426,185, filed Nov. 14, 2002, and U.S. Provisional Application No. 60/491,719, filed Aug. 1, 2003, which are incorporated by reference herein.

### FIELD OF THE INVENTION

The invention relates to wipes formed from water-insoluble substrates having applied thereto cleaning compositions containing bleach. The wipes are particularly suitable for use in hand dishwashing processes and accordingly the invention provides methods of dishcare using wipes of this type.

### BACKGROUND OF THE INVENTION

It is well known to remove soils and stains from dishware and other household surfaces by application of a cleaning composition containing surfactant and other cleaning ingredients. Certain types of soil are particularly difficult to remove. For instance, dried-on or baked-on combinations of proteinaceous and greasy soils are difficult to remove from dishware. Further, stains and rust are also difficult to remove from dishware and household surfaces.

It is known in general that bleach compounds can aid in removal of soils from dishware and household surfaces. For instance, bleach is a common ingredient in compositions provided for automatic dishwashing. Such compositions tend to contain very low levels of surfactant, if any.

The problem remains of removal of difficult soils in processes of dishwashing by hand. Compositions for use in hand dishwashing generally contain relatively high levels of high foaming surfactant, since suds formation is perceived by consumers as an important indicator of cleaning efficacy. Unfortunately, many bleaches tend to be incompatible with many surfactants, and on storage they tend to interact such that either the bleach or the surfactant or both has reduced efficacy by the time of use.

EP-A-068830 describes substrates which carry porous polymeric material and which are suitable for delivering or absorbing liquids. The only example which includes bleach uses hydrogen peroxide bleach. The article described is not a hard surface cleaner or dishwashing article but is described as useful as a stain remover for use on textile fabrics.

EP-A-211664 also describes an article suitable for wiping surfaces, for instance kitchen and bathroom surfaces. This comprises a substrate having applied thereto three separate compositions. One comprises non-ionic surfactant, perfume, polyhydroxypropylmethacrylate and benzoyl peroxide bleach. The second comprises an absorbent sulfonated polystyrene. The third is abrasive and comprises polyvinylchloride granules, adhesive and thickener. This publication is primarily concerned with improving soil removal by providing an abrasive surface.

It would be desirable to provide means suitable for hand dishwashing and cleaning by hand of other household surfaces, but in particular hand dishwashing, which give improved removal of difficult soils. It would also be desirable to provide such means in which efficacy of the cleaning components is maintained during storage.

We find that it is possible to obtain good soil removal, even using cleaning compositions which contain high levels of surfactant (and thus exhibit high suds formation and are perceived by the consumer as effective), when a cleaning composition containing bleach is provided on a water-insoluble substrate in the form of a wipe. This form also allows the separate application of surfactant-containing composition components and bleach-containing composition components which can be maintained separate until the time of use, thus improving stability.

### SUMMARY OF THE INVENTION

Therefore according to a first aspect of the invention we provide a wipe comprising a water-insoluble substrate having applied thereto a cleaning composition comprising:
(a) a surfactant and
(b) a bleach which is a peroxy carboxylic acid or a hydrophilic precursor thereof.

We find that a wipe is a particularly appropriate means of providing both surfactant and bleach directly and simultaneously to the surface to be cleaned, for instance dishware, thus allowing improved soil removal.

Furthermore, the use of peroxy carboxylic acid bleaches and hydrophilic precursors thereof has the benefit that the bleach has affinity for the soils, which tend to contain hydrophilic functional groups such as proteins and carbohydrates. Thus the bleach can begin oxidation and increase porosity of the soil. This increased porosity allows improved, deeper penetration of other cleaning ingredients such as surfactant.

We also find that in this environment it is possible to control release of the bleach by including in the cleaning composition applied to the wipe a defined water-soluble thickening polymer. Therefore according to a second aspect of the invention we provide a wipe comprising a water-insoluble substrate having applied thereto a cleaning composition comprising
(a) a surfactant,
(b) a bleach and
(c) a water-soluble thickening polymer which has anionic side chains and/or side chains which are anionic when in the cleaning composition itself.

Advantageously, the side chains are carboxylate chains and preferably the polymer is a polysaccharide.

The wipes of the invention are useful in methods of cleaning hard surfaces, for instance household surfaces such as kitchen and bathroom surfaces but are particularly beneficial in dishcare methods for cleaning soiled dishware.

Accordingly in a further aspect of the invention there is provided a method of dishcare comprising the steps of providing a disposable wipe having applied thereto a cleaning composition comprising
(a) a surfactant and
(b) a bleach,
and cleaning the dishware either by wetting the wipe with water and applying the wetted wipe to soiled dishware or by wetting the dishware and applying the wipe to the wetted dishware.

### DETAILED DESCRIPTION OF THE PREFERRED EMBODIMENTS

Bleach

In all aspects of the invention it is essential that the substrate has applied thereto a composition which comprises a bleach. Any bleach known for detergent use may be used, as appropriate. In the first aspect of the invention the bleach is a peroxy carboxylic acid bleach or a hydrophilic precursor thereof. Preferably the bleach is chosen from aliphatic C₁₋C₂₂ peroxy carboxylic acids and precursors thereof, in particular aliphatic C₉ to C₁₆ peroxy carboxylic acids and precursors thereof. Particularly suitable peroxy carboxylic acids in this class include pernonanoic acid, n-nonanoyl-6-aminopercaproic acid and diperoxydodecane dioic acid.

Other preferred bleaches are aromatic C₇ to C₃₀ peroxy carboxylic acids and precursors thereof, preferably C₇ to C₂₀ heteroaromatic peroxy carboxylic acids. Particularly preferred examples include phthalimidoperoxyhexanoic acid (PAP), described in EP-A-349940, and other compounds of the formula: 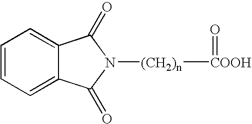
in which n can be from 1 to 18. In PAP n is 5.

Other preferred aromatic bleaches are substituted perbenzoic acids (e.g. meta-chloroperoxybenzoic acid, magnesium monoperoxyphthalate).

The bleach system may also comprise other components such as bleach activators to boost the action of the bleach. Examples of bleach activators are tetracetyl ethylene diamine (TAED), NOBS, acyl triethyl citrate, nonylamide of peradipic acid (e.g. as discussed in US4259201), sodium 3,5,5-trimethylhexanoyloxybenzene sulfonate (e.g. as discussed in U.S. Pat. No. 4,818,425), N-acyl caprolactams (acetoyl-undecanoyl caprolactams), imine and oxaziridine based bleach activators.

In addition, the system may include bleach catalyst to improve oxidation kinetics. Examples of bleach catalysts are complexes of transition metals such as Co, Mn and Fe.

The bleach system may additionally comprise a hydrophobic bleach compound. Examples are diacyl peroxides, (e.g. benzoyl peroxide), di-alkyl peroxides (e.g. di-tert-butyl peroxide), and peroxyesters (e.g. tert-butyl peroxy acetate).

In another aspect of the invention, the bleach is a hydrophilic bleach or precursors thereof. Preferably, the hydrophilic bleach is a perboric acid, percarbonic acid, hypochloric acid or a hypobromic acid; salts thereof; or precursors thereof. Hydrophilic bleaches and precursors thereof have been found to provide excellent cleaning performance in removing highly coloured soils, especially carotenoid soils, from plastic dishware. Carotenoid soils, such as α-, β-, γ-carotene and lycopene and xanthophylls (zeaxanthin or capsanthin), are derived from carrots and tomatoes and in any processed products containing these components, as well as certain tropical fruits and saffron.

Exothermically hydrating salts, such as for example K₂CO₃ or MgSO₄, may be used in combination with these hydrophilic bleaches, to generate heat when contacted with water, to increase the bleach activity.

The total amount of bleach in the composition applied to the substrate can range from 1 to 30%, preferably 3 to 20%, by weight of composition.

We find that the inclusion of bleach in the wipe provides the benefit of reduction of malodor. In particular, we find that inclusion of bleach reduces malodor from the wipe itself, which can otherwise arise after one or more uses.

In the present invention the bleach acts by formation of a peroxy anion. Thus it does not act by means of a free radical reaction (the composition applied to the substrate generally does not contain free radical initiators). The composition applied to the substrate is thus preferably such that in use it provides an alkaline aqueous environment, generally of pH from 8 to 12, preferably 8 to 10.

A further advantage, which we find is associated with the ability to include specific types of bleach in cleaning wipes is reduction of discoloration of the wipes during use. In particular, we find that wipes of the invention preferably show a change in whiteness (L, measured as discussed below) of not more than 25%, preferably not more than 20%, more preferably not more than 15% and in particular not more than 10% from whiteness before use, based on whiteness before use.

Surfactant

The composition applied to the substrate also comprises a detergent surfactant. This may be selected from the conventional surfactants known for use in dishcare compositions. Generally the surfactant is selected from anionic surfactants, amphoteric surfactants, non-ionic surfactants and zwitterionic surfactants and mixtures thereof. Preferred anionic surfactants include alkyl ethoxy sulfates. Preferred non-ionic surfactants include alcohol ethoxylates. Preferred amphoteric surfactants include amine oxides.

The amount of surfactant in the composition applied to the substrate is generally in the range of from 20 to 70%, preferably 30 to 60%, by weight of composition.

Thickening Polymer

In a preferred embodiment the composition applied to the wipe also comprises a water-soluble thickening polymer. We find that the inclusion of such a polymer has the benefit that the release of bleach from the substrate into the aqueous cleaning environment is controlled.

The polymer has anionic side chains, and/or side chains which are anionic when in the cleaning composition itself, and preferably has a pKa in the range of 4 to 20.

Thus the side chains may be acid groups provided that the pKa of those acid groups is sufficiently low that under the pH conditions prevailing in the cleaning composition they are in the sort form. Generally acid groups having pKa 8.5 or below form anionic side chains in the cleaning composition and preferably pKa is not more than 8. Generally it is at least 4 and is preferably from 4 to 7. The side chains can be for instance carboxylate, sulfate or sulfonate and the polymer can be provided to the composition in the acid or the salt form provided that the salt form is present in the composition.

We believe that the inclusion of polymers having anionic side chains is beneficial over use of neutral polymers, at least in part due to the greater ability of anionic polymers to form a network which inhibits dissolution of the surfactant. Benefits also exist over cationic polymers, we believe because the majority of surfactants used in dishwashing cleaning compositions are anionic and the use of anionic polymers prevents excessive complexation between the surfactant and the polymer which might lead to failure to release all of the desired surfactant.

The anionic side chains are preferably carboxylate groups and we find that a particularly preferred class of materials having carboxylate side chains is polysaccharides and polysaccharide derivatives. These give particularly good controlled release results.

Preferred polymers also comprise hydroxyl groups or other groups capable of exhibiting hydrogen bonding, as we believe this contributes to the control of release.

Preferably the polysaccharide or polysaccharide derivative has a molecular weight of 1×10⁵ to 9×10⁷, preferably 5×10⁵ to 5×10⁶.

In another preferred embodiment of the invention, the polysaccharide or polysaccharide derivative is selected from the group consisting of xanthan gum, cellulose, modified celluloses, guar gum and gum arabic and mixtures thereof. Preferably the polysaccharide or polysaccharide derivative is selected from the group consisting of xanthan gum and guar gum. Most preferred is xanthan gum, preferably with a molecular weight of approximately 10⁶. Derivatives of xanthan gum can be used provided they retain the anionic side chains and, preferably, hydroxyl groups.

In another preferred embodiment of the invention, the water-soluble polymer is a polyvinyl alcohol (PVA). The anionic charge is then formed in the composition by deprotonation of the hydroxyl groups, converting them to alkoxide groups having a pKa of between 8 and 14. The PVA preferably has a molecular weight of between 10,000 and 60,000 daltons, and is preferably partially hydrolysed to improve its dispersibility in the cleaning composition. The degree of hydrolysis is preferably 85% to 90%. In the partially hydrolysed form, PVA has both anionic and hydrophobic characteristics that are surfactant-like, resulting in excellent sudsing characteristics.

Other preferred polymers that form anionic side chains when in the cleaning composition itself, are polyacrylic acids and polyvinyl pyrrolidone.

The water-soluble thickening polymer may be intimately combined with the surfactant or alternatively may be located in a separate location on the substrate.

Suitable amounts of polymer are in the range from 2 to 12%, preferably from 4 to 8%, more preferably from 5 to 7% by weight, based on weight of composition applied to the substrate.

It is preferred that the level of water soluble thickening polymer is from 3 to 30%, preferably 5 to 25%, based on the weight of peroxy carboxylic acid or precursor bleach in the composition.

Water Transfer Agent

In a preferred embodiment the composition also comprises a water transfer agent which acts as a structurant. Suitable water transfer agents are particulate materials which are capable of absorbing free water from the composition, in particular free water associated with the surfactant and/or the bleach. We find that the presence of such water transfer agents or structurants has the further benefit that release of surfactant and bleach from the composition into the aqueous cleaning environment is controlled.

The water transfer agent is capable of withdrawing water from the surfactant. By “capable of withdrawing water from the surfactant” it is meant that there is a greater affinity between water and the water-transfer agent than there is between water and the surfactant.

In a preferred embodiment of the invention the water-transfer agent is selected from the group consisting of inorganic oxides and salts, especially hydratable oxides and salts, in particular oxides and salts of silicon, aluminium, zinc, boron, phosphorus, alkaline earth metals and alkali metals and mixtures thereof. Examples include silicates, silicic acid and silica, citric acid, citrates, sodium and potassium tripolyphosphates, sodium and potassium sulfates, magnesium and calcium sulfates. Preferably, the water-transfer agent is selected from the group consisting of silica, salts of magnesium and mixtures thereof.

More preferably the water-transfer agent is silica, preferably amorphous fumed silica. Hydrophobic silica does not act as water transfer agent as it does not possess the necessary hydrophilicity.

Preferably the water transfer agent has surface area measured by BET (described in DIN 66131 and as originally described in JACS, Vol. 60, 1938, p309 by Brunauer, Emmet and Teller) of from 5 to 800 m²/g. More preferably the water-transfer agent has a surface area of from 100 to 400 m²/g.

In an alternative preferred embodiment, the silica has an average particle size of from 0.05 to 1 μm, preferably from 0.2 to 0.3 μm.

Preferably the composition applied to the substrate comprises from 2.5 to 15% water-transfer agent, more preferably 5 to 10% and most preferably about 6%.

Cyclodextrin

In some embodiments we find that it is preferred to include a cyclodextrin in the composition. In particular we include cyclodextrin which encapsulates the peroxy carboxylic acid bleach or hydrophilic peroxy carboxylic acid bleach precursor. This can also provide the benefit of controlling release of bleach over time.

The preferred level of cyclodextrin, if used, is in the range of from 14 to 28 wt % based on total composition applied to the substrate. Preferred levels are from 40 to 80 wt %, based on total bleach in the composition.

Any of the known cyclodextrins can be used, for instance α-cyclodextrin, β-cyclodextrin and γ-cyclodextrin, with hydroxypropyl-beta-cyclodextrin and methyl-beta-cyclodextrin being preferred.

Other Ingredients

The composition applied may also comprise other components suitable for use in dishcare or other surface cleaning compositions. In particular, in some embodiments it is preferred to include enzymes such as protease, amylase and peroxidase.

Preferably the composition applied to the substrate also comprises a particle dispersant for the bleach or bleach precursor, if this is present in the form of particles, such as PAP. Any appropriate polymeric dispersant may be chosen. Examples include dimethylterephthalate-1,2-propylene glycol-sulfo-ethoxylate copolymer.

The composition applied to the substrate may also comprise additives which boost grease cleaning, for instance amines such as 1,3-cyclohexane bis (methylamine). It may also comprise suds boosters, often in the form of (meth) acrylate polymers such as poly dimethyl aminoethyl methacrylate.

A further preferred component is a bleachable dye. Such a dye is preferably provided in a form such that it is released slowly from the composition during use. When bleach activity is effective the bleachable dye is discoloured. However, when bleach activity is exhausted the bleachable dye becomes visible, thus giving a convenient indicator to the user. For example, a pH sensitive indicator can be used to deliver a visible color change on the wipe, due to acidity of the bleach. The preferred indicator is bromothymol blue. The substrate is preferably hydrophobic (e.g. hydrophobic nonwoven fabric), so that due to hydrophobicity of the substrate, the indicator readily absorbs onto it. Due bleach acidity, the presence of bleach, especially PAP, will give a slight yellow hue on the wipe. During wipe use, as PAP is released, the wipe pH increases due to excess surfactant reaching pH 8. This is the pH at which the indicator changes color to dark green. This gives a signal that PAP (or other acidic bleach) has been depleted on the wipe.

Water-Insoluble Substrate

The wipes of the invention comprise a water insoluble substrate. Preferably this substrate comprises at least two layers, a first layer and a second layer (preferably a batting layer).

The layers herein have an interior and exterior surface (sides of the layers). In both cases, the interior surfaces of the layers are those which face the inside or innermost portion of the wipe of the present invention whereas the exterior surfaces of the layers are those which face the outside or outermost portion of the article. Indeed, the two interior sides or surfaces of said first and said second layer face each other and are positioned adjacent to each other. However, as described herein below one or more additional layers may be present between said first and said second layer. These additional layers, when present, are sandwiched between said first and said second layer.

Preferably, the substrate layers are of different textures with the first layer being softer than the second layer, which additionally has an abrasive coating melded onto the side facing away from said first layer (“exterior surface”), meaning that the abrasive coating is on one of the outside surfaces of the wipes herein.

Generally, the orientation of the wipes of the present invention may be defined such that said first layer is closer to the side of the article suitable for gripping (i.e., the gripping side) while the second layer having an abrasive coating on its outside surface is closer to the side of the article to be contacted with the surface to be cleaned (i.e., the primary dish contact side). Both sides of the article, however, are suitable for contact with the dishware.

The design described above of the water insoluble substrate is believed to enhance the cleaning performance of the wipes herein. The substrate has differing textures on each layer or side such that the gripping side of the article is a different texture from the primary dish contact side. The substrate may act as an efficient abrasive or even scouring implement. By physically contacting with the dishware the second layer having an abrasive coating, the substrate significantly aids in cleaning and removal of dirt and soil such as grease, burnt-on food residues and other debris. Furthermore, the preferably softer, first layer is suitable for wiping surfaces and/or provides a soft touch for the user of the wipes herein.

Additionally, the first layer and the second layer, as well as additional layers, when present, are preferably bonded to one another in order to maintain the integrity of the article. The layers are preferably heat spot bonded together more preferably using heat generated by ultrasonic sound waves. The bonding may be arranged such that geometric shapes and patterns, e.g. diamonds, circles, squares, etc., are created on the exterior surfaces of the layers and the resulting article.

First Layer

The water insoluble substrate used in the present invention preferably comprises a first layer, wherein said first layer is a partially hydrophobic nonwoven.

By “partially hydrophobic” it is meant herein that the nonwoven at least partially comprises hydrophobic material. Preferably, the nonwoven of the first layer comprises at least about 40%, more preferably at least about 50%, even more preferably of from about 55% to about 75% of hydrophobic material. Hydrophobic materials are generally based on synthetic organic polymers. Suitable hydrophobic materials herein are selected from the group consisting of synthetic organic polymers.

Materials suitable for the first layer are selected from the group consisting of cellulosic nonwovens, non-lofty nonwovens, and absorbent nonwovens and combinations thereof. Preferably, the first layer is a non-lofty nonwoven. As used herein, “nonwoven” means that the layer does not comprise fibers, which are woven into a fabric. The fibers present in the nonwoven can either be random (i.e., randomly aligned) or they can be carded (i.e., combed to be oriented in primarily one direction).

The first layer may comprise a variety of both natural and synthetic fibers or materials. As used herein, “natural” means that the materials are derived from plants, animals, insects or byproducts of plants, animals, and insects. The conventional base starting material is usually a fibrous web comprising any of the common synthetic or natural textile-length fibers, or combinations thereof.

Nonwovens made from natural materials consist of webs or sheets most commonly formed on a fine wire screen from a liquid suspension of the fibers. See C. A. Hampel et al., The Encyclopedia of Chemistry, third edition, 1973, pp. 793-795 (1973); The Encyclopedia Americana, vol. 21, pp. 376-383 (1984); and G. A. Smook, Handbook of Pulp and Paper Technologies, Technical Association for the Pulp and Paper Industry (1986); which are incorporated by reference herein in their entirety.

Natural material nonwovens useful in the present invention may be obtained from a wide variety of commercial sources. Suitable commercially available paper layers useful herein include Airtex®, an embossed air-laid cellulosic layer having a base weight of about 71 gsm, available from James River, Green Bay, Wis.; and Walkisoft®, an embossed air-laid cellulosic having a base weight of about 75 gsm, available from Walkisoft U.S.A., Mount Holly, N.C.

Methods of making nonwovens are well known in the art. Generally, these nonwovens can be made by air-laying, water-laying, meltblowing, co-forming, spunbonding, or carding processes in which the fibers or filaments are first cut to desired lengths from long strands, passed into a water or air stream, and then deposited onto a screen through which the fiber-laden air or water is passed. The resulting layer, regardless of its method of production or composition, is then subjected to at least one of several types of bonding operations to anchor the individual fibers together to form a self-sustaining web. In the present invention the nonwoven layer can be prepared by a variety of processes including, but not limited to, air-entanglement, hydroentanglement, thermal bonding, and combinations of these processes.

The substrate preferably has a weight of from about 20 gm⁻² to about 200 gm⁻². More preferably, the substrate has a weight of at least about 20 gm⁻² and more preferably less than about 150 gm⁻², more preferably the base weight is in the range of about 20 gm⁻² to about 120 gm⁻², and most preferably from about 30 gm to about 110 gm⁻². The substrate may have any caliper. Typically, when the substrate is made by hydroentangling, the average substrate caliper is less than about 1.2 mm at a pressure of about 0.1 pounds per square inch. More preferably the average caliper of the substrate is from about 0.1 mm to about 1.0 mm at a pressure of about 0.1 pounds per square inch (about 0.007 kilograms per square meter). The substrate caliper is measured according to standard EDANA nonwoven industry methodology, reference method #30.4-89.

In a preferred embodiment according to the present invention said first layer is a carded, spunlaced partially hydrophobic nonwoven.

In another preferred embodiment according to the present invention said partially hydrophobic nonwoven of said first layer consists of at least about 40%, preferably of from about 50% to about 75%, more preferably of from about 55% to about 65% of synthetic fibres.

In yet another preferred embodiment according to the present invention said partially hydrophobic nonwoven of said first layer comprises polypropylene and rayon fibres.

Second Layer

The water insoluble substrate of the present invention further preferably comprises a second layer, wherein said second layer is a low density nonwoven. Preferably, said second layer is a batting layer.

By ‘batting layer’ it is meant herein a nonwoven structure of high loft, resiliency and low density.

By ‘low density’ or lofty nonwoven it is meant herein that the layer has a density of from about 0.00005 g/cm³ to about 0.1 g/cm³, preferably from about 0.001 g/cm³ to about 0.09 g/cm³ and a thickness of from about 0.04 inches to about 2 inches at 5 gms/in².

Said second layer is adjacent to said first layer and preferably has melded onto the side facing away from said first layer an abrasive coating, for instance a polymeric scrim.

In a preferred embodiment according to the present invention said second layer has a loft of at least about 1 mm, preferably of from about 2 mm to about 4 mm.

In another preferred embodiment according to the present invention said second layer has a density of from about 0.00005 g/cm³ to about 0.1 g/cm³, preferably from about 0.001 g/cm³ to about 0.09 g/cm³.

Materials suitable for the second layer are selected from the group consisting of cellulosic nonwovens, lofty nonwovens, and absorbent nonwovens and combinations thereof. Preferably, the first layer is a lofty nonwoven.

The second layer may comprise a variety of both natural and synthetic fibers or materials. Suitable natural materials are the same as described herein above in the section titled ‘First Layer’. Suitable synthetic materials are the same as described herein above in the section titled ‘First Layer’.

Low density nonwoven made from synthetic materials useful in the present invention can be obtained from a wide variety of commercial sources.

In a preferred embodiment according to the present invention said low-density nonwoven consists of polyethylene terephthalate (PET), and bicomponent sheath core fibers made from polyethylene (PE) and polyethylene terephthalate (PET).

In a preferred embodiment according to the present invention said second layer is made of a high loft, low density nonwoven preferably carded through air bonded structure.

In a preferred embodiment the second layer has melded onto the side facing away from said first layer an abrasive coating of thermoplastic material nubs or hooks. These are preferably applied in a pattern of about 8 dots per square inch. Preferably they cover the second layer substantially regularly. The thermoplastic material is preferably hot melt adhesive. It preferably has melting point lower than that of the low density nonwoven of the second layer. It can be applied for instance by screen printing. The nubs or hooks preferably have a substantially globular shape. Diameter is preferably at least about 200 microns, preferably from about 300 to about 600 microns, more preferably from about 300 to about 500 microns.

Additional Layers

Optionally, the substrate herein may comprise one or more optional layers located between said first layer and said second layer. In a preferred embodiment according to the present invention, the water insoluble substrate herein additionally comprises a third substantially water-impermeable layer located in-between said first layer and said second layer. By ‘substantially water-impermeable’ it is meant herein that the layer has a low but not significant level of permeability for water. Preferably, said third substantially water-impermeable layer is a plastic film more preferably a plastic film made from linear low density polyethylene (LDPE) and metallocene catalyzed low density polyethylene. Preferably, said plastic film has a thickness of about 0.8 mm. Preferably, said third water-impermeable layer has an embossed micropattern. It has been found that such an embossed micropattern provides low noise during use. A suitable material for said water-impermeable layer is commercially available from Tregedar under the trade name EMB-685®.

Form and Application of Cleaning Composition

The wipes of the invention are provided by application of the defined cleaning composition to a water-insoluble substrate. The composition can be a single component composition comprising all required ingredients. However it is preferably provided in the form of two or more separate composition components. In particular it is preferred that a first composition component comprises surfactant and substantially no peroxy carboxylic acid or peroxy carboxylic acid precursor bleach and a second composition component comprises the bleach and substantially no surfactant. In this case the two composition components are generally applied to the substrate so that they are discrete and do not come into contact. This particular embodiment has the advantage that incompatible components such as surfactant and bleach can be kept separate.

It is preferred that if enzyme is used this is included in a composition component other than the composition component containing the bleach. In particular, in a preferred embodiment the composition comprises three components, a first comprising bleach, a second comprising surfactant and a third comprising enzyme. These are applied to the surface of the substrate discretely.

The total level of cleaning composition (total of all composition components if separate components are used) on the substrate is generally in the range of from 0.1 to 1 mg/mm², preferably 0.5 to 0.8 mg/mm². The composition or composition components can be applied in uniform manner over the entire surface of the substrate. However, and preferably, the compositions or composition components are applied in the form of stripes (discussed further below).

Generally each composition component is provided in the form of an aqueous composition, such as a paste, containing water and the desired cleaning ingredients which is then applied to the substrate and allowed to dry.

In the invention we find that beneficial bleach release results are achieved when the level of bleach in an aqueous composition containing bleach is from 5 to 60 wt %, preferably 20 to 50 wt %, based on aqueous composition. Preferred levels in a bleach-containing aqueous composition component of water soluble thickening polymer, when used, are in the range 0.5 to 15 wt % based on the aqueous composition, preferably 0.4 to 4.5 wt %, in particular from 1.5 to 3.75 wt %. A bleach-containing aqueous composition preferably contains humectant, for instance, glycerol. Preferred levels of humectant are from 1 to 15 wt %, preferably 5 to 12.5 wt %. The bleach-containing composition component can also contain polymeric dispersant, for instance, dimethylterephthalate-1,2-propylene glycol-sulfo-ethoxylate copolymer, preferably in amounts of from 0.05 to 0.75 wt %, more preferably 0.25 to 0.63 wt %. Levels of water can be from 6 to 93 wt %, preferably from 50 to 80 wt %, more preferably 58 to 73 wt %.

Particularly preferred components of a bleach paste (or other aqueous bleach-containing composition for application to the substrate) are as follows, with preferred and more preferred levels for each being given. Most preferably a bleach paste comprises all of these listed components.

| Component | Preferred | More preferred |
|---|---|---|
| PAP | 5 to 60% | 20 to 50% |
| Dimethylterephthalate-1,2-propylene | 0.05 to 0.75% | 0.25 to 0.63% |
| glycol-sulfo-ethoxylate copolymer | | |
| Xanthan gum | 0.4 to 4.5% | 1.5 to 3.75% |
| Glycerol | 1 to 15% | 5 to 12.5% |
| Water | 6 to 93% | 58 to 73% |

Preferred aqueous surfactant-containing compositions for application to the substrate contain from 2 to 85 wt % water, preferably from 4 to 81 wt %, more preferably from 16 to 61 wt %. Preferred amounts of water soluble thickening polymer in a surfactant-containing composition are from 1 to 10%, preferably 1.5 to 8 wt %, more preferably from 3 to 7 wt %. Preferred amounts of water transfer agent/structurant in an aqueous surfactant-containing composition are from 1 to 10 wt %, preferably from 1.5 to 8 wt %, more preferably from 2.75 to 7 wt %. Preferred levels of anionic surfactant are from 5 to 75 wt %, preferably 12 to 65 wt %, more preferably 25 to 54 wt %. Preferred levels of amphoteric surfactant are from 2 to 15 wt %, preferably 2.7 to 13.4 wt %, more preferably 2.7 to 13.4 wt %, most preferably 5.4 to 11.8 wt %. Preferred levels of non-ionic surfactant are from 0.1 to 10 wt %, preferably 0.4 to 5 wt %, more preferably 1.9 to 4.2 wt %. Preferably an aqueous surfactant-containing composition also comprises additional components for improvement of cleaning and sudsing performance at amounts of from 0.25 to 2 wt %, preferably 0.6 to 1.5 wt %.

Particularly preferred components for a surfactant paste (or other aqueous bleach-containing composition for application to the substrate), and their preferred amounts are as follows. A preferred surfactant paste contains all of the listed components.

| Component | Preferred | More preferred |
|---|---|---|
| Anionic surfactant | 12.3 to 61% | 25 to 54% |
| Amine Oxide | 2.7 to 13.4% | 5.4 to 11.8% |
| Non-ionic surfactant | 0.9 to 4.8% | 1.9 to 4.2% |
| 1,3-Cyclohexone bis (methylamine) | 0.2 to 1.2% | 0.45 to 1% |
| Polydimethyl aminoethyl methacylate | 0.08 to 0.4% | 0.15 to 0.35% |
| Fumed Silica | 1.4 to 7% | 2.75 to 8% |
| Xanthan gum | 1.5 to 7.5% | 3 to 7% |
| Water | 4 to 81% | 16 to 61% |

Application of aqueous compositions to the substrate is generally via conventional methods such as sprinkling, dip coating, spraying, slot coating and roll transfer (eg. pressure roll or kiss roll).

The wipes are preferably formed from a two-layer substrate, as discussed above. In this case the paste or other aqueous composition is preferably added to the first layer and the second and further layers are placed on the first layer, preferably, but not always, over the composition. The sheets can be sealed together by heat spot sealing.

When a two-layer substrate is used, the aqueous composition may be applied onto said first layer, said second layer and/or optional additional layer(s), when present. Furthermore, the aqueous composition may be applied onto the interior and/or exterior surfaces of one or several layer(s) of the substrate of the wipe according to the present invention.

Preferably, the aqueous composition is applied onto said second layer, more preferably onto said second layer on the side facing said first layer. Indeed, the aqueous composition is most preferably deposited onto the interior surface of the second layer.

The aqueous composition may be equally distributed over the full surface of the layer(s) it is deposited on or applied onto a part of the surface of the layer(s) it is deposited on. Preferably, said composition is applied onto a part of the surface of the layer(s) it is deposited on, more preferably onto a part of the surface of said second layer.

The composition applied to the substrate may be equally distributed over the full surface of the substrate or applied onto a part of the surface. Preferably the composition is applied onto parts of the substrate. More preferably the composition is applied in a stripe pattern. Preferably the stripe pattern has at least one stripe, preferably from 1 to 6 stripes, more preferably 3 to 6 stripes and even more preferably about 5 stripes. Preferably the stripes extend over the full length of the wipe. The stripe or stripes preferably have a width of at least 3 mm, and preferably have a width of 5 mm to 15 mm.

By controlling the heat and pressure applied to the wipe during application of stripes of cleaning composition the composition can be kept in stripe form or caused to merge in to a single continuous film.

The surface area of the composition on the wipe can be used to modify the rate of surfactant release when the wipe is used. In general, fewer, thinner stripes lead to slower release of the surfactant from the wipe. This is believed to be as a result of reduction of the surface area of the composition which is exposed to water during use.

In a preferred embodiment herein, the aqueous composition (and hence the cleaning composition in the final product) herein covers at least about 30% of the surface of at least one of the layers herein, preferably of said second layer, and preferably covers from about 70% to about 95% of the surface of at least one of the layers herein, preferably of said second layer. This is particularly preferred when the composition is applied as a single layer. Preferably the composition does not extend to the edges of the substrate. Thus preferably at least 2%, more preferably at least 5% of the substrate area, at the edges of the substrate, does not have cleaning composition applied. This contributes to control of release of the surfactant.

Preferably also the composition is concentrated away from the central areas of the substrate. This also maximises control of release as the composition is concentrated away from the areas where the consumer exerts most pressure on the wipe in use.

Optional further manufacturing steps include calendering to flatten the wipe, drying, creping, shrinking, stretching or otherwise mechanically deforming.

If a separate bleach-containing composition component is used then the amount of this component on the substrate after drying is preferably in the range 0.004 to 0.04 g/cm², preferably 0.01 to 0.03 g/cm².

If a separate surfactant-containing composition component is used the preferred amount is from 0.02 to 0.06 g/cm², preferably 0.02 to 0.04 g/cm².

Wipes

The wipes of the invention are generally disposable, that is they are disposed of or discarded after a limited number of usage events. By “disposable” herein it is meant that, once exhausted of surfactant, the wipe is thrown away. It is not intended that any additional cleaning composition is applied to the wipe by the consumer to replace the surfactant-containing composition released from the wipe during its use. In particular the wipes of the invention are discarded after less than 25, more preferably less than 15 and particularly less than 10 uses. As an example, a single use in a hand dishcare application is the cleaning by hand dishwashing of a single load of dishes, for instance accumulated during one day in a four person family household.

The wipes of the invention can be such that they are disposed of after only one usage event. However, in some embodiments it is advantageous to make use of the improved bleach release control such that the wipes of the invention can be used at least twice, preferably at least three times.

Preferably the wipes are dry-to-the-touch. Preferably the wipe falls within 4 and 5 on the scale when the following moisture test is applied: A dry sheet of disposable Bounty (tradename) Kitchen Towel is placed over the wipe such that the entire wipe is covered by one layer of Bounty Kitchen Towel. A 3 cm by 3 cm 50 gram weight is placed on top of the wipe and Bounty sheet. The weight is left for 1 minute and then removed. The amount of moisture transferred from the wipe to the sheet of Bounty during the above test method is a measure of the wetness of the wipe. The Bounty sheet is visually graded according to the scale below for the presence of a moisture mark, perceived as a visual difference in appearance of the Bounty sheet when held up to alight source. The scale is based on the percentage coverage of a moisture mark over the 3 cm by 3 cm area of the Bounty sheet which was covered by the weight (weight area).

| Scale | % coverage of the weight area |
|---|---|
| 1 | greater than 80% |
| 2 | 75-80% |
| 3 | 40-75% |
| 4 | less than 10% |
| 5 | less than 5% |

By “dry-to-the-touch” it is meant that the wipes are free of water or other solvents in an amount that would make them feel damp or wet to the touch, such as the touch of a wet wipe or pre-moistened wipe, wherein a substrate is impregnated (ie. soaked) in a liquid and generally low viscosity composition. Thus the wipes of the invention are preferably not of the wet or pre-moistened type.

Preferably also the wipes are substantially dry. That is they exhibit a moisture retention of less than about 12 mg/cm², preferably less than about 6 mg/cm², more preferably less than about 2 mg/cm². The moisture retention is indicative of the dry feel that users perceive upon touching the wipes of the invention as opposed to the feel of “wet” wipes.

In order to determine the Moisture Retention of the present wipes, the following equipment and materials are needed.

| | |
|---|---|
| Bounty ® White Paper | Procter & Gamble SKU 37000 63037 |
| Towel | Basis Weight = 42.14 gsm (grams per |
| | square meter) |
| Balance | Accurate to 0.0 g |
| Lexan ® | 0.5″ thickness |
| (hard, transparent poly- | large enough to cover samples completely |
| carbonate polymer block) | and weighs 1000 g |
| Weight | A 2000 grams weight or combination to |
| | equal 2000 grams |

Next, weigh two paper towels separately and record each weight. Place one paper towel on flat surface (e.g. lab bench). Place the sample article on top of that towel. Place the other paper towel on top of sample article. Next, place the Lexan® and then the 2000 grams weight(s) on top of the sandwiched sample article. Wait 1 minute. After the minute, remove weight(s) and Lexan®. Weigh the top and bottom paper towel and record the weight.

Calculate the Moisture Retention by subtracting the initial paper towel weight from the final weight (after 1 minute) for both the top and bottom paper towels. Add the weight differences obtained for the top and bottom paper towels. Assuming multiple articles are tested, average the total weight differences to obtain the Moisture Retention.

The wipes according to the present invention are generally in sheet form. They may have a length of from about 10 to about 20 cm, a width of from about 10 to about 20 cm and a thickness of from about 2 to about 5 mm.

Methods of Cleaning

The wipes of the invention can be used in processes of cleaning dishware by hand and also, although less preferably, processes for cleaning other household surfaces by hand. “Dishware” includes dishes, cups, cutlery, glassware, food storage containers, cooking utensils (cookware) and the like. Household surfaces include hard surfaces found in kitchens such as sinks, worktops, fixtures, appliances etc.

Therefore the invention provides a method of cleaning a hard surface using a wipe according to the invention, wherein the surface is preferably dishware. Methods of cleaning dishware generally comprise wetting the wipe with water and contacting the wetted wipe with the dishware or wetting the dishware with water and contacting the wipe with the wetted dishware.

We have found that the medium of a disposable wipe is a particularly convenient vehicle for application of both surfactant and bleach directly to dishware in order to address the problems of difficult soils discussed above. Use of a disposable wipe environment allows both surfactant and bleach to be applied directly whilst, if desired, being maintained in separate composition components so as to minimise interaction and instability.

We also find that the vehicle of a disposable wipe allows a composition to be provided in convenient form which is substantially dry and dry to the touch, thus improving stability of the ingredients of the composition, whilst allowing them to remain easily soluble in use and able to produce an aqueous cleaning composition rapidly.

Therefore according to a further aspect of the invention we provide a method of dishcare comprising providing a disposable wipe having applied thereto a composition comprising a surfactant and a bleach and either wetting the wipe with water and applying the wetted wipe to soiled dishware or wetting soiled dishware and applying the wipe to the wetted soiled dishware.

The wipes of the present invention are preferably water-activated and are therefore intended to be wetted with water prior to use. As used herein, “water-activated” means that the present invention is presented to the consumer in substantially dry form and/or dry-to-the-touch form to be used after wetting with water. Accordingly, the article is wetted by immersion in water or by placing it under a stream of water.

In this aspect of the invention a variety of bleaches can be used but preferably they are peroxy carboxylic acids or hydrophilic precursors of peroxy carboxylic acids.

In use the wipe is generally mechanically agitated over the dishware (wipe) and the dishware is rinsed with water.

In a preferred embodiment, the present invention also relates to a process of cleaning a hard surface, preferably a kitchen hard surface. The process of cleaning a hard surface comprises the steps of: a) wetting the wipe according to the present invention with water and b) contacting the hard surface with the wetted wipe. Additionally the process of cleaning a hard surface herein additionally comprises the step of mechanically agitating the wipe over said hard surface (wiping) and/or rinsing said hard surface with water.

As discussed above, the wipes of the invention are generally disposable and used only a limited number of times. However, an advantage of the invention is the controlled release of bleaching agent to the washing environment which can be achieved with the invention. This is determined as discussed below in the examples. The method disclosed is particularly applicable to measurement of PAP as the bleach. However, it may be used for measurement of release of any bleach by selection of the appropriate conversion factor in step 6. In some preferred embodiments bleach release is controlled so that less than 50% is released after one day, preferably less than 40% and in some preferred cases less than 30%. It can be preferred for less than 50%, in particular less than 40% and even less than 30% to be released after two day's use. In certain preferred embodiments release is less than 60%, preferably less than 50% and in particular less than 40% after three days.

Optional Additional Ingredients

The cleaning composition used in the wipe according to the invention may comprise any other suitable components known for use in dishcare or hard surface cleaning.

The composition may for instance contain diamines, polymeric suds stabilisers, film-forming polymers, colorants, perfume and perfume delivery agents, stabilizers, solvents, density control agents, drying agents, hydrotropes, salt, solidification agents, preservation agents, water spotting/filming/drying control agents, and mixtures thereof.

Dishwashing Sponges

The cleaning compositions of the invention can also advantageously be applied to dishwashing sponges and in a further aspect of the invention we provide a dishwashing sponge having impregnated therein a cleaning composition comprising:
(a) a surfactant, and (b) a bleach, which is a peroxy carboxylic acid or a hydrophilic precursor thereof.

Alternatively the composition can comprise (a) a surfactant, (b) a bleach and (c) a water-soluble thickening polymer having anionic side chains.

In these aspects preferred features of the composition discussed above may be used as applicable.

The sponge can also have an abrasive layer. The sponge can be formed from, for instance, natural cellulose or synthetic material.

### EXAMPLES

### Example 1

A bleach paste is formed having the following composition:
40% PAP
0.5% dimethylterephthalate-1,2-propylene glycol-sulfo-ethoxylate copolymer
3% Xanthan Gum
10% Glycerol
46.5% water

A surfactant paste is formed having the following composition:
49% alkyl ethoxy sulphate having average 0.6EO groups per molecule (anionic surfactant)
10.7% amine oxide (amphoteric surfactant)
3.8% Neodol 91-8 non-ionic surfactant
0.92% 1,3-cyclohexane bis (methylamine)
0.31% polydimethylamino ethyl methacrylate
5.5% fumed silica
6% Xanthan gum
23.8% water

A substrate 120 mm×140 mm in area is prepared. The substrate comprised a polymeric scrim layer, two batting layers, a polymeric membrane layer and a nonwoven topsheet layer (arranged in that order). The compositions were positioned between one of the batting layers and the polymeric membrane layer.

The surfactant paste is applied to one side of the batting layer of the substrate by extruding it through a coating head continuously in five lines about 12 mm wide separated by a distance of 20 mm, measuring widthwise across the web, making parallel lines on each side of the web. The bleach paste is applied in the same manner, also in stripes such that the bleach paste and surfactant paste do not come into contact on the substrate.

The second layer that already carries the pastes is continuously fed over the first substrate placing the first layer in contact with the surfactant-containing layer. The webs are continuously fed to an ultrasonic sealer, which seals a tilde shaped dot pattern comprising a grid of 8 mm long sealing points spaced evenly across the web. The web is cut into individual articles measuring about 120 mm×160 mm rectangles with rounded corners, which has a total of about 70 sealing points per article.

The two compositions are allowed to dry and the final weight of dried bleach-containing composition on the wipe is 4 g and the final weight of dried surfactant-containing composition on the substrate is 7.5 g.

### Example 2

This example demonstrates improved prevention of discoloration achieved in the invention. Wipes A and B are prepared. Wipe A is as described in Example 1 and wipe B differs in that the application of the bleach paste is omitted.
1. Wipes A and B are prepared.
2. Wipe is immersed in 0.8 l water and a hydrophobic red dye is introduced as a model soil at 2.5% level.
3. Each wipe is dipped into a separate beaker three (3) times squeezing the excess water out of the wipe in between each dip.
4. When all three dips have been completed, excess soap/oil is rinsed off the wipe.
5. Excess water is removed by wringing the wipe which is then allowed to dry overnight.

Results

| Wipe | L (Whiteness) | A (Yellow) | B(Red |
|---|---|---|---|
| Untreated Wipes A and B | 98.14 | 0.37 | 0.30 |
| (initial reading) | | | |
| Wipe B | 66.09 | 36.75 | 4.41 |
| Wipe A | 93.07 | 10.34 | −0.35 |

It can be seen that the difference in whiteness for wipe A after use is not more than 5% from the initial reading whereas for wipe B it is around 33%. Similarly the higher degree of yellow and red components in wipe B after use are indicative of greater staining.

L,a,b Measurements

1. Using a Hunter Colorimeter, an initial reading of each wipe is taken prior to soiling. L, a, b, are on a uniform color scale used in a color difference meter. The results can then be interpreted following the scale attached below [image]
2. After the wipe has been soiled and has dried overnight, a new reading is taken on the Colorimeter.

### Example 3

This example demonstrates soil removal benefits of wipes A of the invention in comparison with use of a liquid base dishwashing composition applied with a sponge to dishware.

Wipes A produced according to Example 1 have a composition applied to the substrate as shown below. These are compared with a liquid hand dishwashing composition, shown as LDL below, applied to dishware with a sponge. The components are as indicated, with the balance being water. Soil removal results are shown.

| | A | LDL |
|---|---|---|
| Formula | | |
| PAP | 7% | 0 |
| Xanthan Gum | 5% | 0 |
| AE0.6S | 32% | 49% |
| Amine Oxide | 7% | 11% |
| Neodol 91-8 | 2.5% | 3.7% |
| 1,3-bisaminomethyl-cyclohexane | 0.6% | 0.9% |
| Polydimethylaminomethylmethacrylate | 0.2% | 0.4% |
| Fumed Silica | 3.6% | 0 |
| Performance | | |
| Soil Removal (%) | 44% | 18% |

Results are obtained as follows:
Procedure
1. Prepare slides with burnt on Macaroni and Cheese.
2. Slides must be weighed and the weight recorded 3 times:
   a. When the slide is completely clean
   b. After soiling
   c. After treatment
3. Place 1 of the prepared Macaroni & Cheese slides in each of the 3 casserole dishes.
4. Turn tap water on so that it is moderately hot and leave water running throughout the entire test.
5. Place the LDL onto a scrubby sponge if necessary.
6. Run the sponge and/or wipe under the faucet.
7. Squeeze the sponge/wipe a couple of times in order to get suds going.
8. Run the sponge/wipe back under the faucet.
9. Squeeze the sponge/wipe over top of the slides in the three casserole dishes. Be sure each slide gets completely covered. Repeat step 7 if necessary.
10. Allow the slides to soak for 30 seconds.
11. Remove the slides from the casserole dish and wipe three times with the sponge/wipe.
12. Place the sides to the side and allow them to dry overnight.
13. Repeat steps 4-11 for each product that needs to be tested.
14. After sufficient drying time, re-weigh the slides in order to determine the amount of soil removed.
   (After treatment−Clean side)/(After soiling−Clean Slide)=% Soil Removed

### Example 4

This experiment demonstrates the effectiveness of Xanthan Gum and cyclodextrin in controlling release of bleach from the wipe in use. Wipe A is as produced in Example 1. In wipe D Xanthan Gum is omitted. In wipe E Xanthan Gum is omitted and replaced with cyclodextrin.

Testing is carried out as follows:

Method for Measuring PAP Activity

Equipment

3 l water (desired water hardness)
Waterbath to keep water at 115F
Reflectoquantt system—Reflex 2 bleach measuring system commercially available from
Merck
Test strips for peracetic acid analysis commercially available from Merck (1-50 ppm range)
Wipes
   Steps 1-3 Represent Single Wash but Multiple Use (Total Bleach in Solution in 1 Day Use)
1. Place wipe in 3 l of 115F water for 15 seconds and squeeze 1×
2. Measure PAP in solution using RQ flex 2 system (calorimetric reflectance via iodine-starch complex on strips)
3. Repeat steps two more times
4. Total bleach is the sum of PAP released in solution after wipe squeezed 3×
   Step 4 Represents 2^{nd} and 3^{rd} Wash (Bleach Measurement for 2^{nd} and 3^{rd} Day of Use)
5. Repeat steps 1,2 and 3 for the second and third day of measurment. The wipe is dried in between successive days.
   Calculating % PAP in Solution:
6. Calculate the ppm (mg/l) of PAP in solution by mutiplying the instrument reading (reflectance) by a conversion factor (MW PAP/MW peracetic acid (277/77=3.6)).

% PAP (solution)=Instrument Reading×[(MW PAP)/(MW Peracetic Acid)]

Results are as follows:

| Day | D | A | E |
|---|---|---|---|
| 0 | 0 | 0 | 0 |
| 1 | 90 | 20 | 25 |
| 2 | 98 | 28 | 37 |
| 3 | 99 | 29 | 42 |

The higher the value of PAP in solution the greater the bleach release. It can be seen that in wipe D 90% is released after day 1. However wipes E and, especially, A exhibit to extended release. Therefore if high initial release is required a wipe of type D should be used and if delayed and controlled release is required then wipes A and E are desirable.

### Example 5

This experiment demonstrates the effectiveness of hydrophilic bleach (hypobromite) in removing highly coloured stains from plastic.

Testing is carried out as follows

Method for Staining Plastics:

1. Using a 3-4 quart pan preheat, to 180F, the entire contents of 1 48-oz. Ragu 100% traditional spaghetti sauce on a hot plate or hob (cover the pot to speed heating).with the burner on low/medium. Stir the sauce occasionally to ensure complete heating.
2. Next, stain plastics in 180F spaghetti sauce by immersing plastic spatula into spaghetti sauce for 30 seconds.
3. Pull spatulas straight out of sauce and allow to drain for 10 seconds.
4. Tap spatulas on side of pan 3 times to remove excess sauce.
5. Immediately rinse spatulas in hot city water, avoiding direct contact with the stain if possible.
6. Completely dry the spatula with a Kim-Wipe or equivalent until no stain is seen on it (may take more than one Kim-Wipe).
7. Set stained spatulas on trays and cover tightly with aluminum foil (light fades the stain).
   Method for Stain Removal
1. Wipes are impregnated with composition F, as shown below, with paste components added separately from the powder components.
2. Powder and paste components are compartmentalized via heat sealing the areas where powder and paste were applied to prevent mixing of components prior to use.
3. Wipes are wetted with 50 mL of water and wrapped on the stained spatulas.
4. Wipes are left wrapped on spatula for a period of 10 minutes to approximate consumer soaking habit.
5. Wipes are removed and spatulas rinsed, dried and stain removal determined using a Hunter colorimeter method discussed previously.

Wipes F are compared with a liquid hand dishwashing composition, shown as LDL below, applied to dishware with a sponge.

| Formula | F | LDL |
|---|---|---|
| Powder Components: | | |
| NaDCC (Sodium 1,3-dichloroisocyanurate) | 10.3% | 0 |
| NaBr (Sodium Bromide) | 9.3% | 0 |
| K₂CO₃ (Potassium Carbonate) | 12.5% | 0 |
| Paste components: | | |
| AE0.6S | 49.9% | 49% |
| Amine Oxide | 11.3% | 11% |
| Neodol 91-8 | 3.7% | 3.7% |
| 1,3-bisaminomethyl-cyclohexane | 1.0% | 0.9% |
| Polydimethylaminomethylmethacrylate | 0.3% | 0.4% |
| Polyvinyl alcohol | 1.6% | 0% |
| H₂O | 0 | 35% |

Results are as follows:

| | Exposure | | | | % Red Stain (b) | % Yellow Stain |
|---|---|---|---|---|---|---|
| Treatment | (minutes) | L (white) | a (Yellow) | b (Red) | Removal | (a) Removal |
| NaDCC/K₂CO₃/NaBr | 10 | 86.06 | 2.93 | 9.66 | 64.9 | 82.6 |
| LDL | 10 | 77.58 | 15.35 | 24.78 | 9.9 | 8.9 |

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

1. A wipe comprising a water-insoluble substrate having applied thereto a cleaning composition, said cleaning composition comprising:
(a) a surfactant; and
(b) a bleach, comprises at least one of the following:
(i) a peroxy carboxylic acid or a hydrophilic precursor thereof; and
(ii) a hydrophilic bleach or precursor thereof.

2. A wipe according to claim 1 wherein the bleach is a peroxy carboxylic acid or a hydrophilic precursor thereof.

3. A wipe according to claim 1 in which the bleach comprises a bleach selected from the group consisting of aliphatic C₁-C₂₂ peroxy acids and precursors thereof.

4. A wipe according to claim 1 in which the bleach comprises a bleach selected from the group consisting of aromatic C₇₋₃₀ peroxy acids and precursors thereof.

5. A wipe according to claim 1 wherein the bleach is selected from the group consisting of perboric acid, percarbonic acid, hypochloric acid or a hypobromic acid, salts thereof; and precursors thereof.

6. A wipe according to claim 1 in which the composition applied to the substrate further comprises a water-soluble thickening polymer having anionic side chains.

7. A wipe according to claim 6 in which the side chains are carboxylate groups.

8. A wipe according to claim 6 in which the water-soluble thickening polymer is a polysaccharide.

9. A wipe according to claim 1 in which the composition applied to the substrate further comprises a water-soluble thickening polymer having side chains which are anionic when in the cleaning composition itself.

10. A wipe according to claim 9 in which the water-soluble thickening polymer is selected from the group consisting of a polyvinyl alcohol, a polyacrylic acid, a polyvinyl pyrrolidone, and mixtures thereof.

11. A wipe according to claim 10 in which the water-soluble thickening polymer is a polyvinyl alcohol having a molecular weight of between 10,000 and 60,000 daltons, and is partially hydrolyzed.

12. A wipe according to claim 1 in which the composition applied to the substrate further comprises a water-transfer agent selected from inorganic salts and oxides.

13. A wipe according to claim 12 in which the water-transfer agent comprises a compound selected from hydratable oxides and salts.

14. A wipe according to claim 1 in which the composition applied to the substrate further comprises cyclodextrin and the bleach is encapsulated by the cyclodextrin.

15. A wipe according to claim 1 in which the composition is formed by a first composition component comprising surfactant and a second composition component comprising bleach and the first and second composition components are applied to discrete areas of the substrate.

16. A wipe comprising a water-insoluble substrate having applied thereto a composition comprising:
(a) a surfactant;
(b) a bleach; and
(c) a water-soluble thickening polymer,
wherein the water-soluble thickening polymer has anionic side chains and/or side chains which are anionic when in the cleaning composition itself.

17. A wipe according to claim 16 in which the polymer has carboxylate side chains.

18. A wipe according to claim 16 in which the polymer is a polyvinyl alcohol.

19. A wipe according to claim 16 in which the polymer is a polyacrylic acid or a polyvinyl pyrrolidone.

20. A wipe comprising a water-insoluble substrate having applied thereto a first cleaning composition component comprising:
(a) a surfactant
and a second cleaning composition component comprising
(b) a bleach,
wherein the first and second composition components are applied to discrete areas of the wipe.

21. A wipe according to any of claims 16-20, wherein the bleach is a hydrophilic bleach or precursor thereof.

22. A wipe according to claim 21, wherein the hydrophilic bleach is selected from the group consisting of perboric acid, percarbonic acid, hypochloric acid or a hypobromic acid, salts thereof; and precursors thereof.

23. A method of removing carotenoid soils from plastic dishware comprising contacting dishware having carotenoid soils thereon with a wipe according to claim 1 comprising a bleach comprising hydrophilic bleach, or precursors thereof.

24. A method of cleaning a surface using a wipe according to claim 1.

25. A method according to claim 24 wherein the surface cleaned is dishware.

26. A method of caring for dishes comprising the steps of:
providing a disposable wipe having applied thereto a cleaning composition comprising:
(1) a surfactant; and
(2) a bleach;
wetting said wipe with water; and
applying the wetted wipe to soiled dishes in order to remove soils.

27. A method of caring for dishes comprising the steps of:
providing a disposable wipe having applied thereto a cleaning composition comprising:
(1) a surfactant; and
(2) a bleach;
providing soiled dishware;
wetting said soiled dishware with water; and
applying the wipe to the wetted soiled dishes in order to remove soils.

28. A process for producing a wipe according to claim 1 comprising providing a water-insoluble substrate and applying thereto an aqueous paste comprising the bleach.
